(19) United States
(12) Patent Application Publication
(10) Pub. No.: US 2016/0153579 A1
(43) Pub. Date: Jun. 2, 2016

(54) DEVICE AND SYSTEM FOR WIRELESSLY CONTROLLING AND MONITORING OF QUARTER TURN VALVES

(71) Applicant: ELTAV WIRELESS MONITORING LTD., Raanana (IL)

(72) Inventors: Israel Radomsky, Herzliya (IL); Ohad Gal, Ramat Hasharon (IL)

(21) Appl. No.: 14/899,525

(22) PCT Filed: Jun. 19, 2014
(86) PCT No.: PCT/IL2014/050557

§ 371 Date: Dec. 17, 2015

(30) Foreign Application Priority Data
Jun. 30, 2013 (IL) 227260

(51) Int. Cl. F16K 31/42; F16K 37/00

(52) U.S. Cl. CPC F16K 31/42; F16K 37/0083

(57) ABSTRACT

The invention relates to a wireless valve actuation device for a quarter turn valve actuator which comprises: (a) a pressurized air input line; (b) a short range wireless receiver for receiving an actuation message from a control center, said message being conveyed to the device via a gateway; (c) a pressurized air activated actuator which is connected to an air output of a first solenoid and to a stem of the quarter turn valve, said actuator is designed to cause variation in an angular orientation of the stem based on an air pressure as received from said output of the first solenoid; (d) a first solenoid for opening a channel between said air input line and said output line to the actuator, upon receipt of an actuation signal; and (e) a controller for receiving said actuation message, and for activating said first solenoid by conveying to it said actuation signal.

### FIELD OF INVENTION

The present invention relates to the field of systems and devices for controlling and monitoring a flow of fluids in industrial facilities. More particularly, the invention relates to a system for wirelessly controlling and monitoring quarter turn valves (such as ball valves) by means of pneumatic actuation valve devices.

### BACKGROUND OF THE INVENTION

In today's industrial environment, systems and equipment must perform at levels thought impossible a decade ago. Global competition forces the industry to continuously improve process operations, product quality, yield and productivity with fewer people than ever before. Production equipment must deliver unprecedented levels of reliability, availability, and maintainability as plant managers seek ways to reduce operational and support costs and to eliminate or minimize capital investments. In short, industry must invoke new measures to improve production, performance, safety and reliability while minimizing costs and extending the operational life of new and aging equipment.

Valves and pneumatic actuators are important elements in every process industry. WO2008/078323 by same Applicant discloses a device and system for wirelessly monitoring the status, particularly the angular position of valves in an industrial facility. More specifically, this publication discloses a network of add-on monitoring devices that are mounted on ball valves. The monitoring devices operate in a short range wireless network, such as Bluetooth, Zigbee, etc. Each monitoring device reports from time to time, such as upon event, the status of the respective ball valve to a control center via the short range network.

The monitoring devices of WO2008/078323 may be attached to manually operated ball valves, or to ball valves that are remotely actuated by means of actuation valve devices. The fact that the transmitter of the monitoring device of WO2008/078323 transmits the status of the ball valve either periodically, or upon event, enables the transmitter of the device to stay in a “sleeping state” most of the time, while “waking up” to transmit the status only at times necessity. In this manner of operation, a relatively compact battery can be used, an such battery can last up to several years.

Ball valve (or quarter turn) actuation devices are commonly used for remotely controlling the status of ball valves, i.e., by means of a signal sent from a control center. Typically, the energy for turning a ball valve from a first state to a next state is a pneumatic pressure. In some cases, the pneumatic pressure is used for a two-way actuation of the actuator. In other cases, the pressure is used in only one way, while when the pressure supply terminates, the actuator returns to its original state by means of a spring. There are two typical manners for actuating ball valves, as follows:
a. In an explosive environment (for example, when the control fluid may explode), the use of electricity within the actuation valve device must be done in a very cautious way. In such explosive environment, typically a junction box which is located at least several meters from the actuation valve device is used. Plurality of pneumatic pressure supply lines are provided between the junction box and plurality of respective actuation valve devices. The junction box has a solenoid for each supply line, which controls a respective valve which in turn allows or releases the pressure within the supply line, thereby causing actuation or release respectively a respective actuator. The junction box typically receives a wired control line for each actuation valve device, on which a respective control signal is conveyed from the control center. As shown, in this structure the solenoid is located at the junction box, rather than at the actuation valve device itself.
b. In a non-explosive environment, the activation solenoid is typically positioned at the actuation valve device casing. More specifically, a pressure line is provided to the actuation valve device, and a wired control line is provided to the solenoid. When a need arises for activation, a respective signal is conveyed from the control center to the solenoid, which in turn causes application of pressure on the actuator, and thereby to switch the status of the respective ball valve. As shown, in this arrangement a solenoid is provided within the actuation valve device itself. This latter arrangement is sometimes applied also in an explosive environment, however, in these cases special care is taken to ensure isolation of the electricity from the potentially exploded fluid.

To summarize, in both said typical cases mentioned above a control signal from the control center is conveyed over a respective wire either to the junction box, or separately to each actuation valve device. Such wiring structure is very cumbersome, requires significant installation hours, and if not properly protected, may even cause fire, or other environmental hazard.

In another aspect, in the typical structure a control signal to an actuator may require it to turn the valve's stem to a specific angular position, thereby to cause, for example a 74% opening. Even though WO2008/078323 discloses a monitoring unit which can report wirelessly the angular position of the stem, or more specifically, to provide a feedback to the control center that the requested control has indeed been appropriately performed, as mentioned, the actuation valve device itself still requires wires for activation.

It is therefore an object of the present invention to provide a wireless actuation valve device for a ball valve.

It is still an object of the present invention to provide a wireless actuation valve device which is fully air pressure operated, and is independent from any external electricity supply.

It is still another object of the present invention to provide an air pressure operated wireless actuation valve device which can be easily replace any prior art actuation valve device, namely to provide an add-on actuation valve device.

It is still another object of the present invention to provide a combined wireless actuation and monitoring device that are assembled within a same casing.

Other objects and advantages of the invention will become apparent as the description proceeds.

### SUMMARY OF THE INVENTION

The invention relates to a wireless valve actuation device for a quarter turn valve actuator which comprises: (a) a pressurized air input line; (b) a short range wireless receiver for receiving an actuation message from a control center, said message being conveyed to the device via a gateway; (c) a pressurized air activated actuator which is connected to an air output of a first solenoid and to a stem of the quarter turn valve, said actuator is designed to cause variation in an angular orientation of the stem based on an air pressure as received from said output of the first solenoid; (d) a first solenoid for opening a channel between said air input line and said output line to the actuator, upon receipt of an actuation signal; and (e) a controller for receiving said actuation message, and for activating said first solenoid by conveying to it said actuation signal.

Preferably, the quarter turn valve actuation device further comprises (a) a rechargeable battery; and (b) a pneumatic generator which is connected to said pressurized air input line, said generator outputs a charging voltage to said rechargeable battery.

Preferably, the quarter turn valve actuation device further comprises a rectifier for rectifying the output voltage of said generator.

Preferably, the connection between said pneumatic generator and said pressurized air input line is controlled by means of a second solenoid, and wherein said second solenoid is controlled by said controller.

Preferably, said controller blocks the passage between said air input line and said generator during activation of the actuator, or when the battery is fully charged.

Preferably, said quarter turn valve actuation device is combined with a wireless quarter turn valve monitoring device, said combined device comprises a sensor for measuring the angular orientation of the stem, and a wireless transmitter for sending status messages to the control center via said gateway.

Preferably, in the combined quarter turn valve actuation device said sensor provides a feedback relating to the measured angular orientation of the stem to said controller.

Preferably, in the combined quarter turn valve actuation device said feedback is used by the controller to assure appropriate angular positioning of the stem, wherein said angular positioning may be anywhere between open and close positions.

Preferably, said combined quarter turn valve actuation and monitoring device further sends to said control center a status message relating to the orientation of the stem, as positioned by the actuator.

Preferably, the combined quarter turn valve actuation and monitoring device further comprises an air pressure measuring sensor, for measuring periodically the air pressure within the air input line, and upon determination of a drop of pressure, or upon receipt of a message from the control center, reporting accordingly an indication with respect to the air pressure within said air input line to the control center.

Preferably, the quarter turn valve actuation device of the invention comprises two air input lines, for a two way actuator.

### BRIEF DESCRIPTION OF THE DRAWINGS

In the drawings:

FIGS. 1 and 2 show a structure of a typical quarter turn valve 1, such as widely used in the industry for controlling a flow of fluids;

FIG. 3 shows a view of an add-on Valve Monitoring Device;

FIG. 4 provides in block diagram form an exemplary structure of an actuation valve device 10 according to an embodiment of the present invention;

FIG. 5 is a flow diagram which provides an example for the operation of the combined device;

FIG. 6 describes in a block diagram form a structure of a combined device, according to an embodiment of the invention.

### DETAILED DESCRIPTION OF PREFERRED EMBODIMENTS

As noted above, the present invention provides a wireless, battery operated, and add-on actuation valve device for a quarter turn valve (such as ball valve).

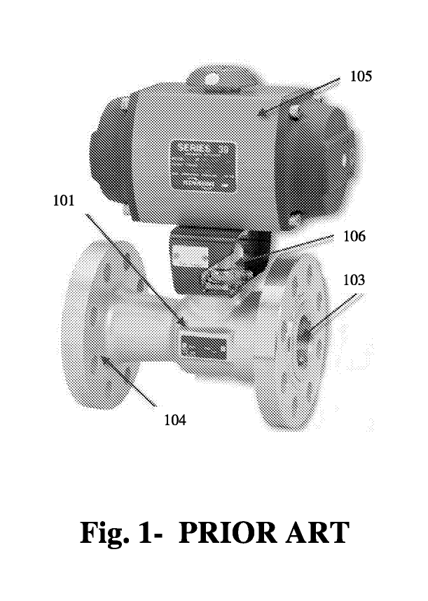

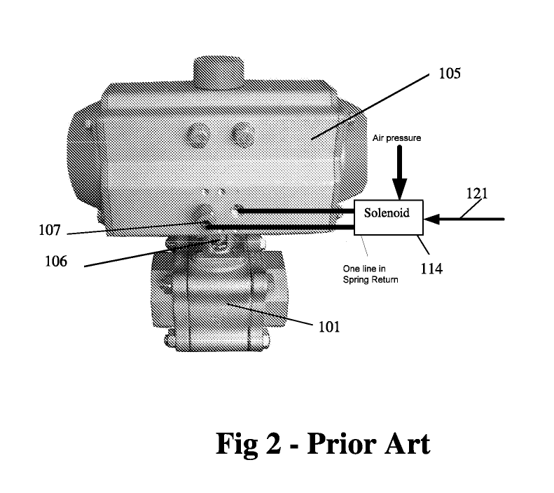

FIGS. 1 and 2 show a structure of a typical quarter turn valve 1, such as widely used in the industry for controlling a flow of fluids. Quarter turn valves are typically sized between ½″ to 12″. A quarter turn valve is typically installed between two sections of a fluid line, and in most cases serves as an open/close flow switch, still, there are cases where the quarter turn valve is positioned at a selected angular position in between said open and close states. This type of valve is typically named “control valve”. Quarter turn type ball valve 101 essentially comprises a hollow section (unseen in the figure), an inlet 103, an outlet 104, and a stem 106 which connects the valve to an actuator 105. Air pressure delivered to an air inlet 107 actuates the valve by moving internal pistons (unseen in the figure) that in turn rotate stem 106 and the valve. After activation of the actuator, it may return to its initial state by another air pressure operated piston or by an internal spring. Typically, the actuator is controlled by an electric signal 121 which is provided by wire to a solenoid 114, which is typically located either within the actuator casing, or within a junction box.

FIG. 2 also illustrates an interaction between a typical actuator 105 and a quarter turn valve 101. When a need arises to change the state of the quarter turn valve 101, a control command 121 is provided from a remote control center to the actuator 105. The control command may be in a form of a fluid pressure (hydraulic or pneumatic), or in a form of an electric signal, and it provides indication to actuator 105 with respect to the direction and magnitude of the desired angular change. In case of hydraulic or pneumatic command, the signal from the control center is delivered to a solenoid which allows an air pressure to enter the actuator. For example, in the case that the quarter turn valve is designed to operate between two states, close and open states, the angular change of the quarter turn valve stem 106 may be 90°. In that case, two stoppers may be provided at respective two end locations of the valve or stem to limit the rotation of the stem 106. The actuator 105, in response to said control command 101, applies a rotational force during some period on stem 106. In response to said angular force, stem 106 rotates within some angular range and direction to change the state of the quarter turn valve 101. Such a change of state may be, for example, a full or partial opening or closure of quarter turn valve 101. In some cases two lines of air pressure are delivered to the actuator, one for clockwise rotation and the other for counterclockwise rotation. In other cases the air pressure rotates the actuator in one direction and a spring returns it backward.

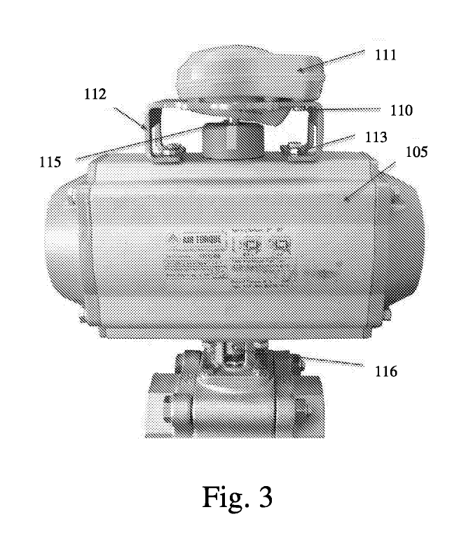

WO 2008/078323 discloses a short-range wireless ball valve (in fact quarter turn valve) monitoring device (VMD) which is installed on an actuated ball valve. In a preferred embodiment of WO 2008/078323, the VMD is an add-on device, which is adapted to be easily installed on an existing actuator even when said actuator is operative. FIG. 3 shows view of such an add-on VMD 111. Initially, a U-shaped supporting element 112 is attached to the existing body of the actuator 105 by one or more screws 113. Monitoring device 111 is attached by screws 110 to the top portion of the supporting element 112. In such a manner, the supporting element 112 and the monitoring device 111 do not disturb the normal operation of the actuator. The valve monitoring device 111 comprises a sensor (not shown in FIG. 3) for reading the status (i.e., angular position) of the actuator 105, and a communication unit (not shown) for periodically, or upon request or event transmitting the status of the actuator and the identification number of the VMD to another device located within the range of transmission of said VMD. Said another short range device may be, for example, a Valve Device Router—VDR, as elaborated in WO 2008/078323.

There are various manners by which the reading of the status of the actuator is performed by the VMD of the WO 2008/078323. The VMD is battery powered (typically about 5 years of battery life) and uses wireless 802.15.4/ZigBee/ISA100.11a/WirelessHart 2.4 GHz or any other wireless frequency range or protocol to wirelessly transmit messages to a control center. A sensor which is associated with the VMD 111 measures the angular position of the VMD shaft 115, which corresponds to an angular orientation of stem 106 in relative to the body of actuator 5. The VMD of WO 2008/078323 reports the valve status upon sensing of a change in the angular orientation of stem 116, and possibly every a predetermined period, for example, every 15 minutes. Still with reference to FIG. 3, the sensing of the angular position of the actuator stem 116 can be performed in various manners, several of them are discussed in WO 2008/078323. For example, shaft 115 may be attached to a potentiometer directly or through a gear spur, and said potentiometer position provides an indication with respect to the angular position of the actuator stem 116.

As noted, said VMD 111 of WO 2008/078323, among other features, determines the angular state of the actuator at any given time, and when a change occurs, it reports this change to a remote location. IL220262 discloses how the VMD 111 can be used to detect at a very early stage a development of an actuator failure, more specifically, when an actuator failure just begins to develop. This is done by analyzing the movement of stem 106, and comparison with a pre-stored data relating to the expected manner of movement.

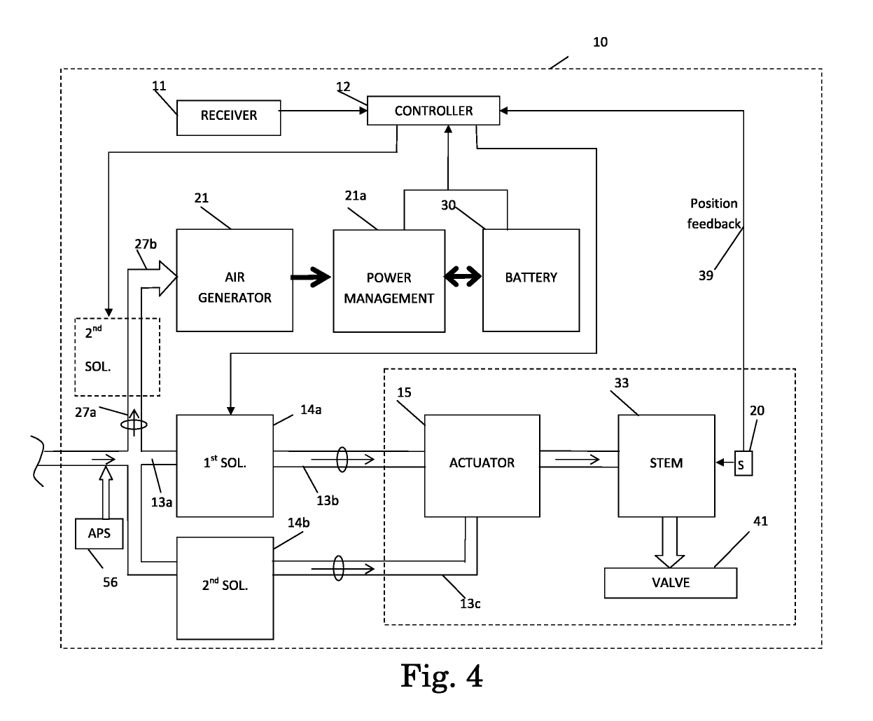

FIG. 4 provides in block diagram form an exemplary structure of an actuation valve device 10 according to an embodiment of the present invention. The actuation valve device comprises a short range wireless receiver 11 which receives control signals from the control center. The control signal from the control center is preferably conveyed wirelessly to the receiver 11 via a router, gateway, etc. In similarity to the monitoring device of WO 2008/078323, the protocol of communication with the actuation valve device may be, for example, Wi-Fi, Bluetooth, ZigBee, ISA100 Wireless HART, or similar. The receiver 11 conveys the received signal to controller 12. Controller 12 detects the signal, and based on the content of the signal, it controls the opening or closure of pneumatic pressure line 13a, by means of 1^{st} solenoid 14a (which in turn opens or closes a respective solenoid valve). The opening of the solenoid valve by solenoid 14a allows a pressurized fluid to flow and activate the actuator 15, which in turn rotates the stem to an appropriate angular position, for example, an “Open State” of the valve. Upon receipt of a next control message from the control center at controller 12 to close the valve , the controller again forwards the command to the 2^{nd} solenoid 14b, causing a return of the valve to its original state. Solenoid 14a may affect this return by means of causing a pressure on stem in an opposite direction (“Close State”)—applicable to AIR-AIR Actuator. In a AIR-Spring Actuator only 1^{st} Solenoid is required. The actuator returns to its “Close State”by releasing the pressure in the actuator by opening 1^{st} Solenoid and releasing the actuator internal pressure and activating the internal spring to cause the actuator to return to its “Close State”.

A wireless actuation valve device consumes much more electrical energy compared to a wireless monitoring device, for example, the one described in WO 2008/078323. Therefore, while a typical battery at the monitoring device can hold up to several years, a battery at the actuation valve device may require replacement once every several days or weeks. The reasons for this excess of consumption are as follows:
a. As described in WO 2008/078323, in the monitoring device, the transmission is performed either periodically or upon event. In the first case of a periodical status transmission, the transmitter of the monitoring device can “sleep” between actual periods, therefore consuming a negligible amount of energy during these relatively long sleeping times. This results in a significant reduction to the energy consumption from the battery. In the second case of “upon event” status transmission, the time of transmission is also initiated at the movement of the quarter turn valve (in contrast to initiation by the remote control center). Therefore, also in this case, and in similarity to the “periodical” transmission case, the monitoring device can “sleep” in the long durations between times of transmission, resulting in a significant reduction of the consumed of energy.
b. In contrast to the monitoring device, the wireless actuation valve device must always stay in a continuous “listening” state, in order not to miss any control command from the control center (that may arrive any time). This continuous “listening” consumes a very significant amount of energy from the battery, which is many orders larger compared to the energy consumption in a wireless monitoring device operating either in a “periodical” or upon even manner.
c. Furthermore, in the case of an actuator for quarter turn valves, and for safety reasons, commonly there is a need to supply most of the time current to the actuator solenoid, such that the quarter turn valve is maintained in its “unsafe” state regularly, while any fault in the electricity, or in the supply of air pressure, will result in the return of the valve to its “safe” state by means of a spring. Operation in this manner results in still additional electricity consumption from the battery.

Therefore, while designing the wireless actuation valve device of the present invention, the inventors had to provide a solution to said high energy consumption from the battery. As will be described hereinafter, this problem has been overcome by the provision of a rechargeable battery at the actuation valve device, and by providing a pneumatic generator for charging the battery.

Returning to FIG. 4, a pneumatic generator 21 is provided, which is connected to pressure line 13a. The pressure from line 13a causes a continuous rotation of the pneumatic generator 21. The current from the pneumatic generator 21 is managed by the Power Management unit 21a which controls the charging of the rechargeable battery 30 and delivers the electric supply to the Controller 12. In such a manner, the rechargeable battery always contains enough energy to feed electrical components of the device, such as the receiver 11, controller 12, and the one or more of solenoids 14 and 24.

Optional 3^{rd} solenoid 24 is controlled by controller 12, and used to activate or deactivate the pneumatic generator 21. More specifically, when 3^{rd} solenoid 24 opens the channel between lines 27a and 27b, the pneumatic pressure activates the pneumatic generator 21, enabling recharge of battery 30. On the other hand, when 3^{rd} solenoid 24 closes this channel, generator 21 stops its operation. There are two typical situations in which the controller may close the channel between lines 27a and 27b, as follows:
a. Controller 12 may check from time to time whether battery 30 is fully charged. At times when it is determined that the battery is full, the 3^{rd} solenoid 24 may be activated to terminate the operation of generator 21. Later on, upon reduction of the charge within battery 30 below a predetermined level, solenoid 24 may reopen the channel in order to resume the charging of battery 30.
b. Typically, the level of pressure within pneumatic line 13a is designed to guarantee an appropriate reliable operation of actuator 15. Typically this pressure ranges between 4 bars and 8 bars. The supply to generator 21 somewhat reduces this pressure, that may in some cases harm a reliable operation of actuator 15. In order to resolve this drawback, the second 3^{rd} 24 may be activated by controller 12 to close the channel between line 27a and line 27b at times of activation of actuator 15, thereby to assure a full pressure at the actuator at these times. The times of actuations of actuator 15 are typically not so frequent, and moreover, their durations are very short, therefore this termination of the generator operation does not cause any significant harm, enabling recharge of the battery almost any time when it becomes necessary.

It should be noted, that in order to assure an appropriate communication between the control center and the device (whether an actuation valve device or a combined actuation and monitoring device), each device is allocated a unique ID. When combining the actuation valve device of the present invention with the monitoring device of WO 2008/078323, the actuation valve device of the invention has still additional advantages. As previously discussed, the monitoring device of WO 2008/078323 comprises an angular sensor that measures the angular orientation of stem 33. Moreover, at any given time the monitoring device can report this orientation to the control center using its short range transmitter. Using these features, a controlled positioning of stem 33 to any desired angular orientation can be performed by the actuation valve device. More specifically, during activation of actuator 15, sensor 20 may measure the temporal orientation of stem 33, and may provide feedback 39 to controller 12. Upon arrival of the stem 33 to the desired angular position, controller 12 may terminate the operation of actuator 15 by controlling the first solenoid 14a to close the channel between lines 13a and 13b. In such a manner, the stem may be brought to any desired angular position, for example, to a 44% of opening of valve 41. Typically, sensor 20 is the sensor of the monitoring device (not shown), and the report to the control center is also made via the transmitter of the monitoring device. However, in some cases, both sensor 20 and said transmitter are included within the same casing of the actuator device 10. As noted, in a most preferable case, the invention relates to a combined actuation and monitoring device that are mounted within a same casing. In any case, whether combined or separated, the actuation valve device, as well as the monitoring device, are provided as add-on devices that can be installed on existing quarter turn valves, without any need for modification either of the controlled line or the devices themselves. In similarity, the controlled process does not have to be disturbed as well while installing the devices. In still another embodiment, the combined air pressure sensor (APS) 56 may be included within the combined actuation and monitoring device. The air pressure within the pneumatic line 13a may be periodically measured, and reported to the control center via the transmitter of the monitoring device section, in order to assure appropriate air pressure. If a level below a predetermined level is reported to the control center, the control center may check and possibly fix the failure. A combined device also enables performance of a PST (Partial Stroke Test) of the actuator and valve. A command may be sent from the control center to open or close the valve for a few percent of the entire angular range, and the monitoring section may monitor that the executed command has indeed been successfully performed. In such a matter, a quality and safety test of the valve 41 and actuator 15 can be performed, as required by some regulations, to ensure that the system is appropriately operational. Such a test can be made only in a combined device that combines both control and monitoring cap abilities.

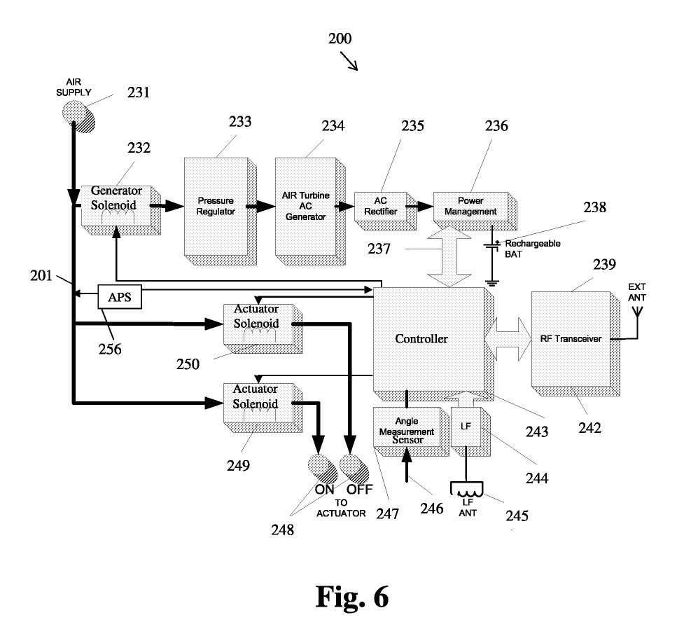

Moreover, the combined device of the present invention can provide feedback to the control center with respect to the proper pressure at the air pressure supply to the actuation device. As shown in FIG. 6, the device further comprises a pressure sensor 256. Upon detection of an input air pressure which is out of a predefined pressure range, controller 243 sends an alert signal to the control center via the RF transceiver 239. This is a very important feature that ensures an appropriate operation of the device, and may further prevent development of failures at their early stages.

To summarize, a combined actuation and monitoring device has at least the following advantages:
a. The combined device enables a feedback based actuation and movement of the valve 41 to any angular position.
b. The combined device enables performance of a PST (Partial Stroke Test) of the actuator and valve.
c. The combined device may also measure and wirelessly and periodically report the level of air pressure of the air supply, and or when failure is detected. This is a very important diagnostic feature.
d. All the above features become available by the combined device. The other features of the separate actuation valve device or the separate monitoring device are not repeated here.

As noted above, when a two-way actuation is desired, two pressure lines may be provided to the actuation valve device, one for closure of the valve 41, and another for opening it.

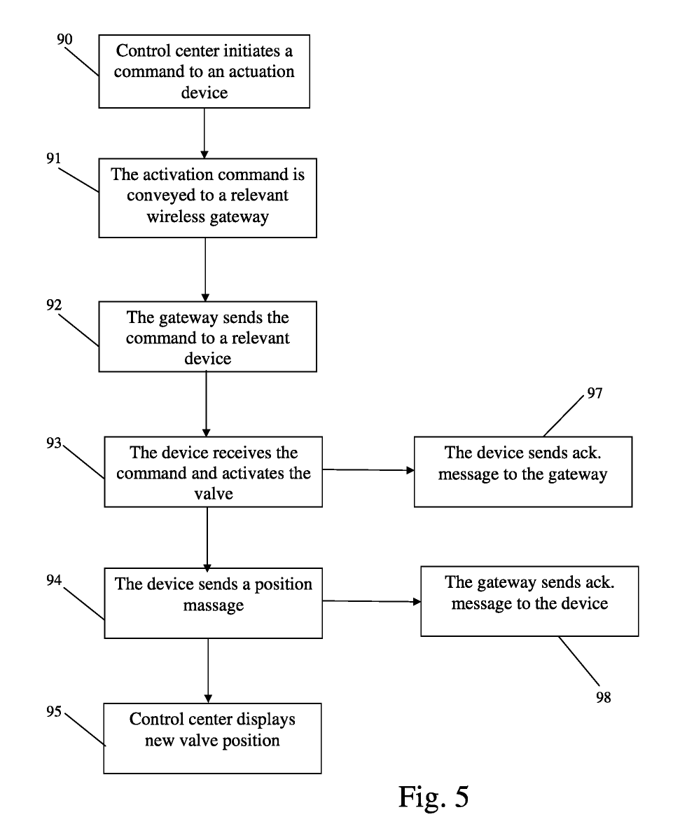

FIG. 5 is a flow diagram which provides an example for the operation of the combined device. In step 90 a user at the control center initiates an activation command to the device. In step 91 the activation command is conveyed to a relevant wireless gateway. In step 92, the gateway conveys the command to the relevant device. In step 93, the device receives the command by its receiver, and activates the valve. Then, in step 97 the device sends an acknowledgment message to the gateway. In step 94 the device sends an additional message for the gateway, informing the new position of the valve. The gateway in turn conveys the message to the control center. In step 98 the gateway sends an acknowledgment message to the device. Finally, in step 95 the control center displays the new valve position to the user.

FIG. 6 describes in a block diagram form a structure of a combined device 200, according to an embodiment of the invention. A pneumatic air pressure is provided to the device via line 201, and is conveyed to the generator solenoid 232, and to two actuator solenoids 249 and 250, that control a two way actuation of the valve respectively. Transceiver 239 is used for receiving actuation commands from the control center, and for transmitting status and other commands to the control center. Controller 243 activates one of the solenoids 249 or 250, based on the received command. Sensor 247 is used for measuring the angle orientation of the stem to assure appropriate operation. The final angle orientation may be conveyed to the control center, for example as described in WO 2008/078323. A low frequency transceiver 244 may also be used to communicate the status of the stem to a very close range, or to calibrate and setup the device in a manner as also described in WO 2008/078323.

Solenoid 232, which is controlled by controller 243 is used for the activation and deactivation of the pneumatic generator 234, by opening and closing the air supply. Pressure regulator 233 regulates the pneumatic pressure to generator 234. AC rectifier rectifies the output voltage from the generator 234, and provides the rectified voltage to power management unit 236, which regulates the charging operation of rechargeable battery 238. The operation of the power management unit is also controlled by controller 243. Controller 243 also controls the operation of the generator solenoid 232. For example, it terminates the operation of the generator 234 when the battery is fully charged, or during the activation, when a provision of a full pressure is required by the actuator.

As noted, the present invention provides a wireless, add on activation device which includes a rechargeable battery. The device also comprises a pneumatic generator for charging the battery, which utilizes the regular air supply to the activation device. In such a manner, a need for a frequent replacement of the battery is eliminated, and the battery may last even several years. Moreover, the actuation valve device of the invention eliminates the need of a junction box, and the need for providing a wire to each activation device, through which the control commands are conveyed to the actuation valve device. When combined with a monitoring device as in WO 2008/078323, the device may also convey to the control center messages relating to the status of the device, to the appropriate execution of each received actuation command, and messages relating to the proper input air pressure as supplied to the device.

As described, in the device of the present invention the solenoids are positioned within the casing of the actuation valve device. In case that the actuation valve device of the invention is designed for use within an explosive environment (namely, the fluid within the controlled pipe is explosive), special arrangements are made within the device to ensure that the solenoids are very well isolated from the explosive fluid, even when a possible failure occurs in the device. In such a structure, technics of Intrinsic Safe (IS) design should be implemented.

While some embodiments of the invention have been described by way of illustration, it will be apparent that the invention can be carried out with many modifications variations and adaptations, and with the use of numerous equivalents or alternative solutions that are within the scope of persons skilled in the art, without departing from the spirit of the invention or exceeding the scope of the claims.

1. A wireless valve actuation device for a quarter turn valve actuator which comprises:
a. a pressurized air input line;
b. a short range wireless receiver for receiving an actuation message from a control center, said message being conveyed to the device via a gateway;
c. a pressurized air activated actuator which is connected to an air output of a first solenoid and to a stem of the quarter turn valve, said actuator is designed to cause variation in an angular orientation of the stem based on an air pressure as received from said output of the first solenoid;
d. a first solenoid for opening a channel between said air input line and said output line to the actuator, upon receipt of an actuation signal; and
e. a controller for receiving said actuation message, and for activating said first solenoid by conveying to it said actuation signal.

2. A quarter turn valve actuation device according to claim 1, which further comprises:
a. a rechargeable battery; and
b. a pneumatic generator which is connected to said pressurized air input line, said generator outputs a charging voltage to said rechargeable battery.

3. A quarter turn valve actuation device according to claim 2, further comprising a rectifier for rectifying the output voltage of said generator.

4. A quarter turn valve actuation device according to claim 2, wherein the connection between said pneumatic generator and said pressurized air input line is controlled by means of a second solenoid, and wherein said second solenoid is controlled by said controller.

5. A quarter turn valve actuation device according to claim 2, wherein said controller blocks the passage between said air input line and said generator during activation of the actuator, or when the battery is fully charged.

6. A quarter turn valve actuation device according to claim 1, which is combined with a wireless quarter turn valve monitoring device, said combined device comprises a sensor for measuring the angular orientation of the stem, and a wireless transmitter for sending status messages to the control center via said gateway.

7. A combined quarter turn valve actuation device according to claim 6, wherein said sensor provides a feedback relating to the measured angular orientation of the stem to said controller.

8. A combined quarter turn valve actuation device according to claim 7, wherein said feedback is used by the controller to assure appropriate angular positioning of the stem, wherein said angular positioning may be anywhere between open and close positions.

9. A combined quarter turn valve actuation and monitoring device according to claim 6, for further sending to said control center a status message relating to the orientation of the stem, as positioned by the actuator.

10. A combined quarter turn valve actuation and monitoring device according to claim 6, further comprising an air pressure measuring sensor, for measuring periodically the air pressure within the air input line, and upon determination of a drop of pressure, or upon receipt of a message from the control center, reporting accordingly an indication with respect to the air pressure within said air input line to the control center.

11. A quarter turn valve actuation device according to claim 1, which comprises two air input lines, for a two way actuator.
